(19) United States
(12) Patent Application Publication
(10) Pub. No.: US 2021/0326949 A1
(43) Pub. Date: Oct. 21, 2021

(54) CATALOG CREATION SUPPORT DEVICE, SUPPORT SCREEN DISPLAY METHOD, AND CATALOG CREATION SUPPORT METHOD

(71) Applicant: Nippon Telegraph and Telephone Corporation, Tokyo (JP)

(72) Inventors: Kensuke Takahashi, Tokyo (JP); Miwaka OTANI, Tokyo (JP); Hiroshi KATO, Tokyo (JP); Nobuo ONAI, Tokyo (JP); Tomoki IKEGAYA, Tokyo (JP); Naoki TAKE, Tokyo (JP)

(21) Appl. No.: 17/265,072

(22) PCT Filed: Jul. 11, 2019
(86) PCT No.: PCT/JP2019/027601

§ 371 Date: Feb. 1, 2021

(30) Foreign Application Priority Data
Aug. 2, 2018 (JP) 2018-145672

(51) Int. Cl. G06Q 30/06; G06N 5/04; G06F 16/93

(52) U.S. Cl. CPC G06Q 30/0603; G06F 16/93; G06N 5/043

(57) ABSTRACT

[Problem] Creation of a catalog used by an API orchestrator and creation of a GUI relevant thereto are facilitated.

[Solution] A catalog definition file 41 including a versatile definition data necessary for catalog creation is managed, and a catalog file creation assistance GUI generation unit 44 automatically generates web-based GUI data 55 to be displayed on a creation assistance screen of a creation target catalog based on the catalog definition file. A catalog file creation assistance GUI unit 45 receives a request from a web browser 51 on the creation assistance screen and replies with an appropriate response. The catalog file creation assistance GUI generation unit 44 dynamically creates the GUI data 55 that can be displayed on the creation assistance screen in response to a request received by the catalog file creation assistance GUI unit 45.

### TECHNICAL FIELD

The present disclosure relates to a catalog creation assistance device, an assistance screen display method, and a catalog creation assistance method.

### Background Art

In a Business to Business to X (B2B2X) business model, a middle B operator can freely combine a plurality of types of primary services provided by a first B operator and provide a resultant service to an end user X as a secondary service. Here, “first B operator” refers to a carrier, a cloud operator of an Infrastructure as a Service (IaaS) or a Platform as a Service (PaaS), an application operator, or the like.

However, because services provided by carriers, cloud operators, application operators, and the like are provided by independent enterprises, specifications differ from each other. Thus, a mechanism for associating services provided by a plurality of first B operators with each other is used. Such a mechanism is referred to as an Application Programming Interface (API) cooperation device or an API orchestrator.

For example, Non Patent Literature 1 describes a technology of an API cooperation device 10 as illustrated in FIG. 1. The API cooperation device 10 illustrated in FIG. 1 includes a catalog interpretation execution unit 11, a service API execution unit 12, and a catalog management unit 13. The service API execution unit 12 includes individual units 12a, 12b, and 12c corresponding to company D, company A, and application (application software) A, respectively.

Catalogs managed by the catalog management unit 13 are data files describing specifications of services required for cooperation among a plurality of services. That is, in the example of FIG. 1, a service specification of a company D network 14, a service specification of a company A cloud 15, and a service specification of an application A 16 are managed by the catalog management unit 13 as catalogs. The catalog interpretation execution unit 11 reads the data files of the respective catalogs managed by the catalog management unit 13, interprets content thereof, and executes cooperation among a plurality of services. The individual unit 12a executes a service-specific API of the company D network 14, the individual unit 12b executes a service-specific API of the company A cloud 15, and the individual unit 12c executes a service-specific API of the application A 16.

### CITATION LIST

### Non Patent Literature

Non Patent Literature 1: Kensuke Takahashi, et al., “Architecture for Flexible Service Cooperation Among Multiple Operators,” Proceedings of IEICE Communications Society Conference, 2017.

### SUMMARY OF THE INVENTION

### Technical Problem

A cooperation service catalog 20 managed by the catalog management unit 13 illustrated in FIG. 1 is configured as illustrated in FIG. 2, for example. That is, a company D catalog 21, a company A catalog 22, and an application A catalog 23 are included in the cooperation service catalog 20. The company A catalog 22 includes respective component corresponding portions 22a, 22b, and 22c of respective applications A. B, and C existing as components of a company A service, and further includes “rule B” as an action rule 22d. The application A catalog 23 includes a component corresponding portion 23a corresponding to the company D network 14, a component corresponding portion 23b corresponding to the company A cloud 15, and a component corresponding portion 23c corresponding to the application A 16, and further includes “rule A” as an action rule 23d.

For example, as illustrated in FIG. 2, there are various types of content of the cooperation service catalog 20 used by the API orchestrator, and it takes a great deal of effort to appropriately create such a catalog.

It is common to use a Graphical User Interface (GUI) to enable a creator to intuitively create the catalog as described above when the catalog is created. Examples of such a graphical user interface include “OpenStack Heat Dashboard” and “AWS CloudFormation Designer.”

However, data of each GUI that can be used at the time of catalog creation is created uniquely for each service by a service provider. That is, each time a new service is developed, a new GUI must be developed for catalog creation, which requires a great deal of effort.

Further, when a GUI is developed for each catalog, a GUI assisting in catalog creation corresponding to a new service must also be simultaneously developed in a case in which the new service is added. Thus, the promptness of the service addition is impaired.

The present disclosure has been made in view of the above circumstances, and an object of the present disclosure is to provide a catalog creation assistance device, an assistance screen display method, and a catalog creation assistance method capable of facilitating creation of a catalog used by an API orchestrator and creation of a GUI relevant thereto.

### Means for Solving the Problem

(1) A catalog creation assistance device that assists with creation of a catalog handled by an API orchestrator controlling cooperation between a first operator and a middle operator, the catalog creation assistance device including a definition file management unit configured to manage a catalog definition file including versatile definition data required to define components, a service specification, and an action rule in a creation target catalog, a GUI generation unit configured to generate GUI data to be displayed on a creation assistance screen for the creation target catalog in a format that at least a web browser is able to display based on content of the catalog definition file, and a GUI unit configured to receive a request from the web browser and reply with an appropriate response in the creation assistance screen, wherein the GUI generation unit creates the GUI data displayable on the creation assistance screen in response to a request from the web browser received by the GUI unit.

With this catalog creation assistance device, the GUI generation unit can automatically generate GUI data to be displayed on the creation assistance screen for the creation target catalog based on the content of the catalog definition file. Thus, when highly versatile content is described in the catalog definition file in advance, it is not necessary to individually prepare programs to generate a GUI for each of catalogs to be created. That is, productivity is improved when a GUI is automatically generated using the content described in the catalog definition file, compared to when a GUI generation program is individually developed for each catalog. Further, because a catalog creator can create a catalog while viewing the GUI displayed via a web browser on the catalog creation assistance screen, the catalog creator can intuitively ascertain a configuration of the catalog or a progress situation of the creation, and productivity in the catalog creation is improved.

(2) The catalog creation assistance device according to (1), wherein the creation assistance screen for the creation target catalog includes a first area for displaying a list of assignable items, a second area having a function of editing a configuration of a catalog to be created, and a third area enabling parameters regarding at least a selected item from assignable items to be displayed and updated.

With this catalog creation assistance device, because a creator who creates catalogs while viewing the catalog creation assistance screen can simultaneously view the list of items, the configuration of the catalog that is being created, and the parameters of the item in respective independent areas on the screen, ascertaining a situation is facilitated.

(3) The catalog creation assistance device according to (2), wherein the GUI generation unit disposes, in the second area, an item selected from a list of assignable items displayed in the first area in response to a drag-and-drop request from the web browser displaying the creation assistance screen for the creation target catalog, and creates the GUI data according to a configuration in the second area.

With this catalog creation assistance device, the catalog creator can dispose the selected item in the second area and edit the item through an intuitive drag-and-drop operation on the catalog creation assistance screen.

(4) The catalog creation assistance device according to (2) or (3), wherein each of items of assignable items that are able to be disposed in the first area and the second area includes a connection parameter indicating a list of information for specifying an access destination and a maximum access count, and the GUI generation unit connects a plurality of items of assignable items disposed in the second area according to the connection parameter in response to a request from the web browser.

With this catalog creation assistance device, a catalog creator can connect a plurality of items disposed in the second area in an appropriate state on the catalog creation assistance screen, and intuitively determine a configuration of the system in the catalog to be created.

(5) The catalog creation assistance device according to (4), wherein the GUI generation unit recognizes, when connecting a plurality of items of assignable items disposed in the second area according to the connection parameter in response to a request from the web browser, whether there is a parent-child relationship between a plurality of connected items of assignable items and represents, when there is a parent-child relationship, a parent-child relationship using a visually distinguishable connection line having directionality.

With this catalog creation assistance device, a catalog creator can see the directionality of the connection line connecting the plurality of items in the second area on the catalog creation assistance screen to intuitively ascertain the parent-child relationship of the plurality of connected items.

(6) An assistance screen display method for displaying a creation assistance screen for assisting with creation of a catalog handled by an API orchestrator controlling cooperation between a first operator and a middle operator, the assistance screen display method including managing a catalog definition file including versatile definition data required to define components, a service specification, and an action rule in a creation target catalog, generating a catalog configuration for specifying a plurality of items, connection relationships between the plurality of items, and parameters of each item of the plurality of items included in the creation target catalog based on content defined by the catalog definition file and an input operation of a user, and displaying, on the creation assistance screen, a layout and a connection relationship between elements in the catalog configuration in a visible state.

With this assistance screen display method, because a catalog creator can edit the GUI generated based on the content of the catalog definition file through an intuitive input operation while viewing the GUI on the screen, it is possible to easily determine a configuration of the catalog.

(7) A catalog creation assistance method for assisting with creation of a catalog handled by an API orchestrator controlling cooperation between a first B operator and a middle B operator, the catalog creation assistance method including, using a versatile catalog definition file serving as a basis for a creation target catalog, and disposing, in the catalog definition file, a catalog information definition portion for specifying basic information of the catalog and an item definition portion for specifying a plurality of items includable in the catalog.

With this catalog creation assistance method, because various types of catalogs can be defined by a common catalog definition specification, versatile use becomes possible. That is, because a definition corresponding to a specification specific to each catalog and a definition indicating a specification specific to each item are independent, it can be dealt with just by redefining a part of the definition even when a type of catalog to be created changes.

(8) The catalog creation assistance method according to (7), wherein the item definition portion includes a first item definition portion for individually defining a single item of the plurality of items, a second item definition portion for defining an item of the plurality of items selectable from among a created group consisting of the plurality of items, and a third item definition portion for defining an item of the plurality of items selectable from among an uncreated group consisting of the plurality of items.

With this catalog creation assistance method, an item can be defined individually by the first item definition portion, an item selectable from among the group created in advance can be defined by the second item definition portion, or a group can be newly created and an item selectable from among the group can be defined by the third item definition portion. That is, a highly versatile catalog definition is possible.

### Effects of the Invention

With the catalog creation assistance device, the assistance screen display method, and the catalog creation assistance method of the present disclosure, it is possible to facilitate creation of a catalog used by an API orchestrator and creation of a GUI relevant thereto. That is, with the catalog creation assistance device of the present disclosure, the GUI generation unit can automatically generate GUI data to be displayed on the creation assistance screen for the creation target catalog based on the content of the catalog definition file.

Further, creation of various catalogs is facilitated by assisting with catalog creation with an automatically generated GUI. Further, with the assistance screen display method of the present disclosure, because a catalog creator can edit the GUI generated based on the content of the catalog definition file through an intuitive input operation while viewing the GUI on the screen, it is possible to easily determine a configuration of the catalog.

Further, according to the catalog creation assistance method of the present disclosure, because various types of catalogs can be defined by a common catalog definition specification, versatile use becomes possible. That is, because a definition corresponding to a specification specific to each catalog and a definition indicating a specification specific to each item are independent, it can be dealt with just by redefining a part of the definition even when a type of catalog to be created changes.

### BRIEF DESCRIPTION OF DRAWINGS

FIG. 1 is a block diagram illustrating an example of a configuration of a known orchestrator technology.

FIG. 2 is a schematic diagram illustrating an example of a configuration of a cooperation service catalog used by an orchestrator.

FIG. 3 is a block diagram illustrating an example of a configuration of a system that implements a B2B2X business model.

FIG. 4 is a block diagram illustrating an example of a configuration of a catalog creation assistance device in an embodiment of the present disclosure.

FIG. 5 is a front view illustrating a basic configuration of a catalog creation screen provided by the catalog creation assistance device according to the embodiment of the present disclosure.

FIG. 6 is a front view illustrating an example of a configuration of a catalog creation screen during catalog creation.

FIG. 7 is a schematic diagram illustrating an example of a relationship between a catalog creation screen and a catalog definition file before and after editing.

FIG. 8 is a schematic diagram illustrating specifications of a catalog definition and an item definition (1).

FIG. 9 is a schematic diagram illustrating specifications of a catalog definition and an item definition (2).

FIG. 10 is a schematic diagram illustrating specifications of a catalog definition and an item definition (3).

FIG. 11 is a schematic diagram illustrating a specific catalog definition example (1).

FIG. 12 is a schematic diagram illustrating a specific catalog definition example (2).

FIG. 13 is a schematic diagram illustrating a specific catalog definition example (3).

FIG. 14 is a schematic diagram illustrating a specific item definition example.

FIG. 15 is a front view illustrating a specific example of a catalog creation screen.

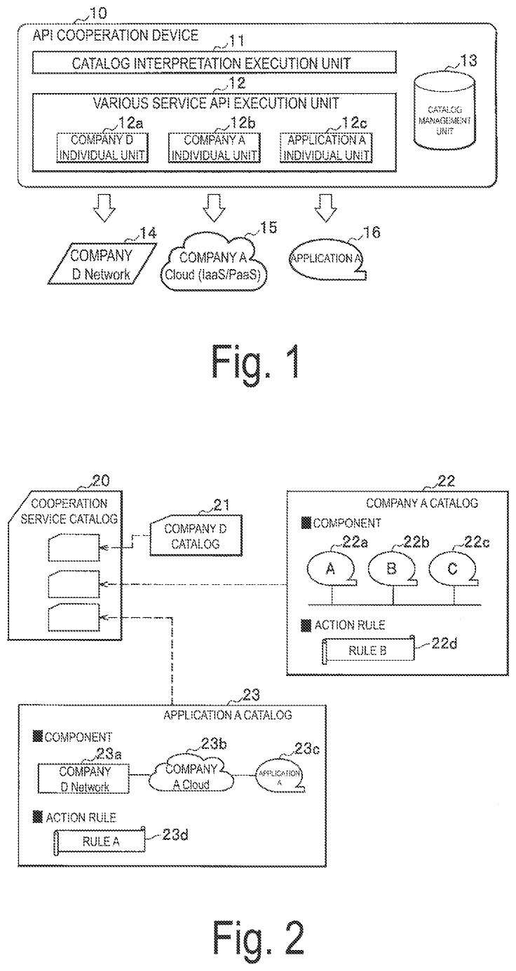

### DESCRIPTION OF EMBODIMENTS

Hereinafter, embodiments of the present disclosure will be described with reference to the respective drawings.

System for Implementing B2B2X Business Model

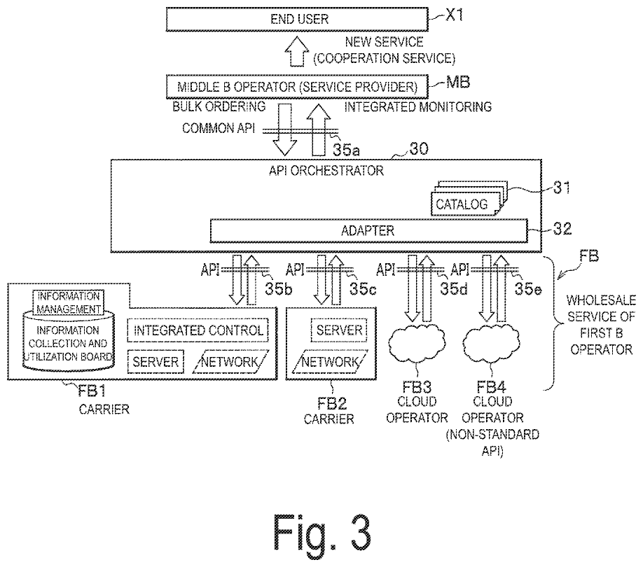

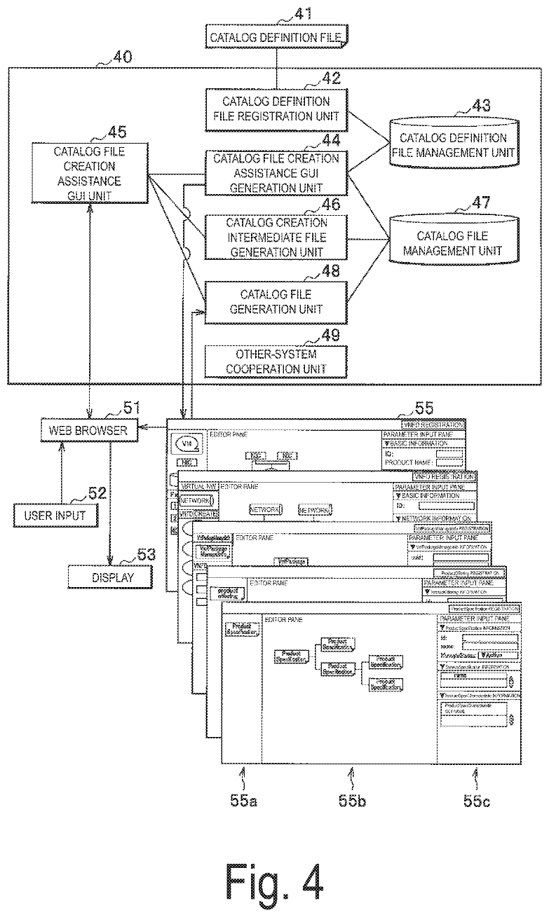

An example of a configuration of a system for implementing a B2B2X business model assumed as a premise of the present disclosure is illustrated in FIG. 3.

In the example illustrated in FIG. 3, for example, equipment of first B operators FB1, FB2, FB3, and FB4 of four companies are connected to an API orchestrator 30 via API frameworks 3.5b, 35c, 35d, and 35e, respectively. Further, equipment of a middle B operator MB, for example, is connected to the API orchestrator 30 via an API framework 35a.

In the example of FIG. 3, the first B operator FB1 is a carrier and includes a server, a network, an integrated control, an information collection and utilization platform, and information management as equipment. Further, the first B operator FB2 is a carrier, and equipment thereof include a network and a server. Further, the first B operator FB3 is a cloud operator that supports a standard of an API, and the first B operator FB4 is a cloud operator that does not support the standard of the API.

The first B operators FB1, FB2, FB3, and FB4 can provide a portion of respective functions as a wholesale service FB to the middle B operator MB or the like. The middle B operator MB may provide a new service to an end user X1 by utilizing and appropriately combining the wholesale services FB of the first B operators FB1 to FB4.

However, the wholesale services FB provided by the first B operators FB1 to FB4 have different specifications for each service of each company. Thus, when the middle B operator MB combines wholesale services FB of a plurality of operators to provide a new service, a difference in specifications among the plurality of services of the wholesale service FB is problematic. The API orchestrator 30 has a function of absorbing such a difference in specifications and causing a plurality of wholesale services FB to cooperate therebetween.

The API orchestrator 30 illustrated in FIG. 3 includes a plurality of catalogs 31 and an adapter 32. The plurality of catalogs 31 include catalogs corresponding to the respective wholesale services FB provided by the first B operators FB1 to FB4, as in the cooperation service catalog 20 illustrated in FIG. 2. Further, each of the catalogs is a data file including at least information of “component,” “service specification,” and “action rule.”

The adapter 32 absorbs a difference between a IMF API to which the API orchestrator 30 conforms and an API provided by each of the wholesale services FB and executes the API of the wholesale service FR The API orchestrator 30 receives an API such as an order of a cooperation service from the middle B operator MB. Further, the API orchestrator 30 performs execution of each related wholesale service FB according to a scenario based on the catalog 31 for cooperation of a plurality of wholesale services FB for the requested order.

Meanwhile, there are various specifications of the wholesale services FB provided by the first B operators FB1 to FB4 illustrated in FIG. 3, for example. Thus, the first B operators FB1 to FB4 have to create various types of catalogs 31 for each service and the catalog creator performs a very troublesome task. Thus, productivity of catalog creation is improved using the catalog creation assistance device to be described below to assist in the catalog creation task of the catalog creator.

Example of Configuration of Catalog Creation Assistance Device

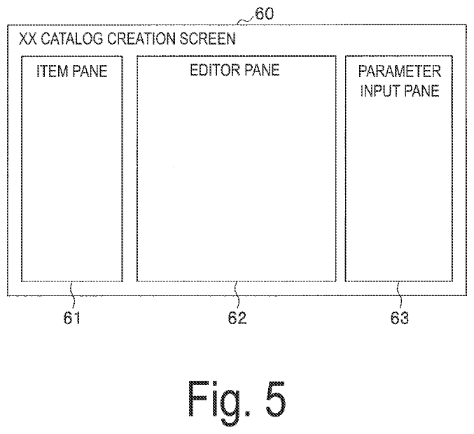

An example of a configuration of a catalog creation assistance device 40 in an embodiment of the present disclosure is illustrated in FIG. 4, That is, for example, when the catalog 31 used by the API orchestrator 30 illustrated in FIG. 3 is to be created by the catalog creator, the catalog can be created efficiently by using the catalog creation assistance device 40.

In particular, because the catalog creation assistance device 40 illustrated in FIG. 4 displays the creation assistance screen using a GUI, the catalog creator can ascertain a creation situation in a state in which the creation situation is easy to intuitively understand. Further, because the GUI of the creation assistance screen is automatically generated based on a catalog definition file 41 as will be described below, it is not necessary for the GUI to be individually developed for each service when an appropriate catalog definition file 41 is prepared.

The catalog creation assistance device 40 illustrated in FIG. 4 includes the catalog definition file 41, a catalog definition file registration unit 42, a catalog definition file management unit 43, a catalog file creation assistance GUI generation unit 44, a catalog file creation assistance GUI unit 45, a catalog creation intermediate file generation unit 46, a catalog file management unit 47, a catalog file generation unit 48, and an other-system cooperation unit 49.

The catalog definition file 41 is a data file describing a definition of information required to automatically generate a GUI suitable for each catalog to be created. Content of the catalog definition file 41 is described by a character string, that is, as text. This content of the catalog definition file 41 is created by a creator of catalog definition files. Work of creating the content of the catalog definition file 41 is similar to the development of programs, but required effort is sufficiently less than in a case in which a plurality of GUI programs are individually developed.

The catalog definition file registration unit 42 has a function of reading content of the catalog definition file 41 created in advance and registering the content in the catalog definition file management unit 43. The catalog definition file management unit 43 holds and manages the content of each of the registered catalog definition files 41.

The catalog file management unit 47 has a function of accumulating and managing a template of a catalog to he created, a file of a created catalog, an intermediate file composed of web-based GUI data corresponding to a catalog that is being created, and the like.

The catalog file creation assistance GUI unit 45 has a function of receiving a Hyper Text Transfer Protocol (HTTP) request or a Hypertext Transfer Protocol Secure (HTTPS) request input from a web browser 51 and returning an appropriate response to the web browser 51. The catalog file creation assistance GUI unit 45 also provides the received request to the catalog file creation assistance GUI generation unit 44.

The catalog file creation assistance GUI generation unit 44 cooperates with the catalog definition file management unit 43 and the catalog file management unit 47 to automatically generate GUI data that is used for catalog file creation assistance based on definition content of the catalog definition file 41. Specifically, the catalog file creation assistance GUI generation unit 44 has a function of dynamically generating data according to specifications such as HTML/Cascading Style Sheets (CSS)/JavaScript corresponding to the request received by the catalog file creation assistance GUI unit 45, that is, GUI data defining a document of a web page.

The catalog creation intermediate file generation unit 46 has a function of temporarily registering data of the catalog during the creation, that is, GUI data generated for catalog creation assistance in the catalog file management unit 47 as an intermediate file so that such data is not erased, in response to, for example, a request according to a user input 52.

The catalog file generation unit 48 has a function of generating a catalog file based on GUI data 55 generated by the catalog file creation assistance GUI generation unit 44 and data of the catalog template managed by the catalog file management unit 47.

The other-system cooperation unit 49 has a function for cooperation with a system that uses this catalog. Specifically, when the catalog creation assistance device 40 creates, for example, catalogs for the API orchestrator 30 in FIG. 3, the other-system cooperation unit 49 has a function of registering the catalog tiles created fir the API orchestrator 30.

The catalog creation assistance device 40 illustrated in FIG. 4 can be configured as application software executable on a terminal such as a personal computer, for example. When the catalog creation assistance device 40 is actually used, the catalog creation assistance device 40 is used with the web browser 51, which is widely used application software. The catalog creation assistance device 40 can use Internet Explorer manufactured by Microsoft Corporation as the web browser 51, for example.

The user input 52 for the terminal is input to the catalog, file creation assistance GUI unit 45 via the web browser 51, and a request for displaying a catalog file creation assistance screen is input from the catalog file creation assistance GUI unit 45 to the catalog file creation assistance GUI generation unit 44.

Further, the GUI data 55 for creation assistance corresponding to content of the catalog file creation assistance screen is generated by the catalog file creation assistance GUI generation unit 44 in response to the request. The generated GUI data 55 is displayed on a screen of a display 53 via the web browser 51.

A user who is creating a catalog using the web browser 51 can view content of the GUI data 55 on the screen of the display 53 to intuitively ascertain a catalog creation situation from visual information, and proceed with the creation of the catalog while performing an operation of the user input 52 with respect to the web browser 51.

Basic Configuration of Catalog Creation Screen

A basic configuration, that is, a framework, of a catalog creation screen 60 provided by the catalog creation assistance device according to the embodiment of the present disclosure is illustrated in FIG. 5. That is, the catalog creation screen 60 as in FIG. 5 is initially created by the GUI data 55 that the catalog file creation assistance GUI generation unit 44 dynamically creates. Further, this catalog creation screen 60 is displayed on the display 53 by the web browser 51.

Further, an item to be first displayed in each of an item pane 61, an editor pane 62, and a parameter input pane 63 or constraints in the editor pane 62 are automatically generated by the catalog file creation assistance GUI generation unit 44 based on data read from the catalog definition file 41.

In the embodiment, the catalog creation screen 60 includes three areas: the item pane 61, the editor pane 62, and the parameter input pane 63 that have been laterally aligned, as illustrated in FIG. 5, This catalog creation screen 60 corresponds to the GUI data 55 generated by the catalog file creation assistance GUI generation unit 44 illustrated in FIG. 4.

The item pane 61 may display each component, that is, item, required when a desired catalog is created.

The editor pane 62 is used to edit a configuration of the catalog to be created. For example, one item displayed in the item pane 61 is selected through an operation of the user input 52, and dragged and dropped (D&D) to the editor pane 62 as a movement destination, such that the item can he disposed as a component of the catalog to be created. Further, content of the item pane 61 is displayed graphically. That is, using an image, a line, or the like of a specific shape pattern indicating each item, a configuration or a connection relationship between items in the catalog is displayed in a form easy to intuitively ascertain through the visual information.

The parameter input pane 63 is used to input information required for the catalog to be created. Information that can he input to the parameter input pane 63 includes two types, “basic information” and “item information.” The “basic information” can be input in a state in which the item is not selected. The “item information” is input as a parameter associated with any item when the item is selected.

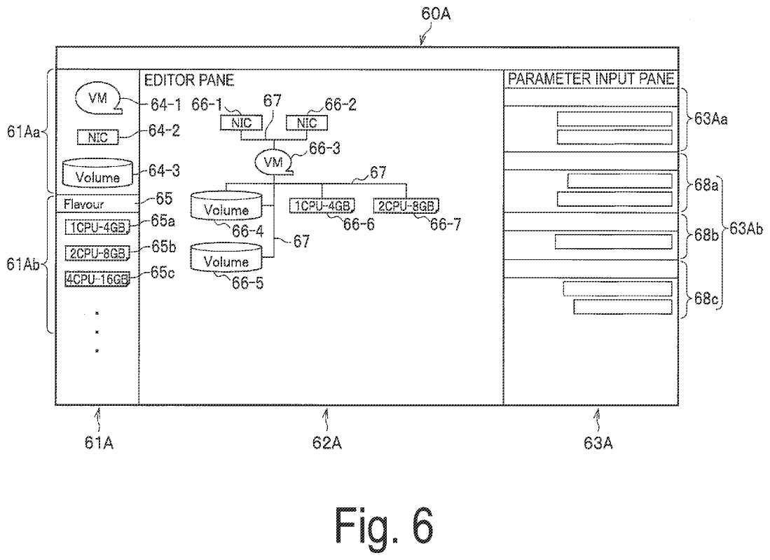

An example of a configuration of a catalog creation screen 60A during catalog creation is illustrated in FIG. 6.

In the catalog creation screen 60A illustrated in FIG. 6, an individual item display portion 61Aa and a created catalog item display portion 61Ab are displayed in the area of the item pane 61A. Further, each of items 64-1, 64-2, and 64-3 is displayed as an image having a specific shape in the individual item display portion 61Aa.

The item 64-1 illustrated in FIG. 6 corresponds to a virtual machine (VM), the item 64-2 corresponds to a network interface card (NIC), and the item 64-3 corresponds to a virtual volume of storage (Volume).

In addition, each of a flavour display portion 65, and a list of a plurality of virtual hardware elements 65a, 65b, 65c, . . . is displayed as a character string or an image having a specific shape in the created catalog item display portion 61Ab.

“Flavour” of the created catalog item display portion 61Ab represents a template of virtual hardware in OpenStack, and includes elements such as the number of cores of a virtual CPU, a virtual memory, and a virtual disk volume. A plurality of templates including respective elements are displayed as the virtual hardware elements 65a, 65b, 65c, . . . .

Display content as in the item pane 61A illustrated in FIG. 6 is displayed by being defined, in advance, in the catalog definition file 41 read by the catalog creation assistance device 40.

A user creating the catalog can perform a drag-and-drop operation to move each of the items displayed in the item pane 61A illustrated in FIG. 6 to an editor pane 62.A with the item selected, and repeat such an operation. As a result, various items can be disposed in the editor pane 62A as in FIG. 6.

In the example of FIG. 6, catalog components 66-1 to 66-7 and 67 are disposed in the editor pane 62A, and a plurality of elements are connected to each other by connection lines of the catalog component 67.

The catalog components 66-1 and 66-2 are the same network interface card as the item 64-2 displayed in the item pane CIA. The catalog component 66-3 is the same virtual machine as the item 64-1 displayed in the item pane 61A. The catalog components 66-4 and 66-5 are the same virtual volume as the item 64-3 displayed in item pane 61A. The catalog components 66-6 and 66-7 are the same template as the virtual hardware element 65a and 65b displayed on the created catalog item display portion 61Ab of the item pane 61A.

Connection lines, that is, items of a connector corresponding to the catalog component 67, can be automatically connected by the user performing a drag-and-drop operation between terminals of a plurality of items to generate GUI data for the items. Further, restrictions of a case in which the plurality of items are connected by the connection lines of the connector are automatically determined based on the content of the catalog definition file 41. For example, a condition that a plurality of items such as NIC, volume, and flavour can be connected to input and output terminals of the virtual machine of single catalog component 66-3 can be defined in the catalog definition file 41. The control described above is performed by the catalog file creation assistance GUI generation unit 44.

A basic information display portion 63Aa and an item information display portion 63Ab are included in the parameter input pane 63A illustrated in FIG. 6. The item information display portion 63Ab includes a VM information display area 68a, an NIC information display area 68b, and a volume information display area 68c.

In the basic information display portion 63Aa, the user can input a catalog ID or an item name as the basic information. Further, in the VM information display area 68a, information for specifying a boot type of the virtual machine and an operating system (OS) can be input in the NIC information display area 68b, a name of the NIC can be input. In the volume information display area 68c, a device name and a size [GB] can be input.

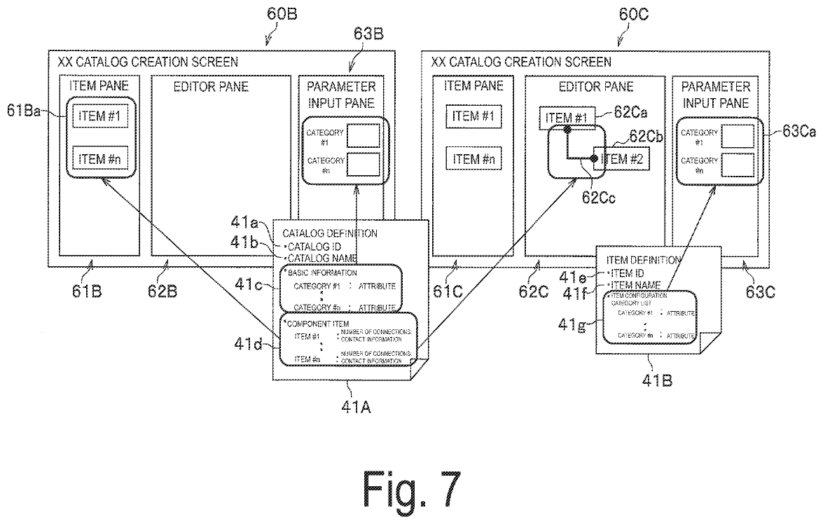

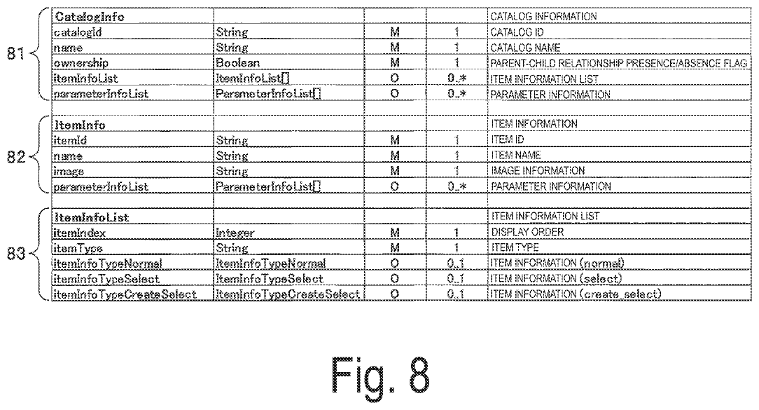

Overview of Correspondence Relationship between Catalog Definition File and GUI An example of a relationship between catalog creation screens 60B and 60C and catalog definitions 41A and 41B before and after editing is illustrated in FIG. 7.

In the example illustrated in FIG. 7, a catalog ID definition portion 41a, a catalog name definition portion 41b, a basic information definition portion 41c, and a component item definition portion 41d are described, according to a specification determined in advance, as text in the catalog definition 41A included in the catalog definition file 41. Further, an item ID definition portion 41e, an item name definition portion 41f, and an item configuration category list 41g are described, according to a specification determined in advance, as text in the item definition 41B included in the catalog definition file 41. A specific specification of the definition will be described below.

As illustrated in FIG. 7, content of the basic information definition portion 41c in the catalog definition 41A is reflected in content of a parameter input pane 63B as a result of the catalog creation assistance device 40 reading the catalog definition file 41. Content of the basic information definition portion 41c includes attributes, that is, information of parameters, regarding each of a plurality of n categories #1 to #n.

Further, the component item definition portion 41d of the catalog definition 41A includes the number of connections and a connection destination, that is, information indicating restrictions of an access destination for each of the plurality of n items #1 to #n.

Content of the component item definition portion 41d is reflected in the individual item display portion 61Ba in the item pane 61B in the catalog creation screen 60B in FIG. 7 as a result of the catalog creation assistance device 40 reading the catalog definition file 41. That is, items that can be used at the time of the creation of the catalog are displayed on the individual item display portion 61Ba.

When each item in the individual item display portion 61Ba is dragged and dropped to the editor pane 62B by an input operation of the user, a result thereof is reflected in an editor pane 62C, as in the catalog creation screen 60C. That is, each of the catalog components 62Ca and 62Cb can be disposed in the editor pane 62C. Further, the two catalog components 62Ca and 62Cb can be connected by a connector of a catalog component 62Cc. In this connection, constraints described in the component item definition portion 41d are automatically applied. For example, control is performed so that terminals of the non-connectable items cannot be connected by the connector.

Content described in the item definition 4113 of the catalog definition file 41 is reflected in an item information display portion 63Ca as a result of the catalog creation assistance device 40 reading the catalog definition file 41. For example, when the user selects “item #1” displayed in the item pane 61C in a state in which the catalog creation screen 60C is displayed, the item information display portion 63Ca associated therewith is displayed in the parameter input pane 63C, and the user is allowed to input or update the parameter.

Details of Specifications of Catalog Definition and Item Definition

Specifications of the catalog definition and the item definition in the embodiment are illustrated in FIGS. 8 to 10. That is, when a catalog definition creator creates the catalog definition file 41, the required matters are described as text in the catalog definition file 41 according to the specifications illustrated in FIGS. 8 to 10.

In the example of FIG. 8, specifications of catalog information (CatalogInfo) 81, item information (ItemInfo) 82, and an item information list (ItemInfoList) 83 are illustrated. In each of the catalog information (CatalogInfo) 81, the item information (ItemInfo) 82, and the item information list (ItemInfoList) 83 in FIG. 8, respective laterally aligned categories represent a name of a definition, data type, an M/O classification, a data range, and a description of each row in order from the left. The M/O classification represents a distinction between M (Mandatory) and O (Optional). Further, “O . . . *” in the data range category represents a range from 0 to infinity, and “0 . . . 1” represents a range from 0 to 1.

The catalog information (Cataloglnfo) 81 includes a catalog ID, a catalog name, a parent-child relationship presence/absence flag, an item information list, and parameter information, as illustrated in FIG. 8. Here, the item information list and the parameter information can he omitted because the M/O classification is “0”, that is, optional. Further, the number of the item information list in the catalog information (CatalogInfo) 81 can be determined in a range from 0 to infinity. The same applies to the parameter information in the catalog information (CatalogInfo) 81.

Data types of the catalog ID, the catalog name, the parent-child relationship presence/absence flag, the item information list, and the parameter information are a character string, a character string, Boolean, an “ItemList” array, and a “ParameterInfoList” array, respectively.

The parent-child relationship presence/absence flag (ownership) in the catalog information (CatalogInfo) 81 represents the presence or absence of the parent-child relationship when components are connected to each other, and is represented as presence: true/absence: false.

In the embodiment, the catalog file creation assistance GUI generation unit 44 performs special control using the parent-child relationship presence/absence flag of the catalog information (CatalogInfo) 81. That is, when there is parent-child relationship and a connector connecting items is drawn, the catalog file creation assistance GUI generation unit 44 generates GUI data including an arrow indicating a direction indicating the parent-child relationship. Further, when there is no parent-child relationship and a connector connecting items is drawn, the catalog file creation assistance GUI generation unit 44 generates the GUI data using an ordinary straight line without directionality.

The item information (ItemInfo) 82 includes an item ID, an item name, image information, and parameter information. The parameter information in the item information (ItemInfo) 82 can he omitted. The number of the parameter information in the item information (ItemInfo) 82 can be determined in a range from 0 to infinity.

The image information in the item information (ItemInfo) 82 consists of a character string indicating a location and a file name of the corresponding image file. For example, images indicating shapes or patterns of the respective items 64-1, 64-2, and 64-3 illustrated in FIG. 6 can he individually designated by the image information in the item information (ItemInfo) 82.

The item information list (ItemInfoList) 83 includes a display order, an item and item information, as illustrated in FIG. 8. The item information can be omitted. Here, available item information includes three types: a disposition type (normal), a selection type (select), and a creation/selection type (create_select). The user can selectively designate any one of the three item types.

The disposition type (normal) item information is a normal item. The selection type (select) item information is an item that has been created as a catalog in advance. Because the selection type (select) item information includes a plurality of items, it is assumed that the user is caused to select one of the items from a list in a state in which the items are displayed as the list in the item pane 61.

For example, in the item pane 61A illustrated in FIG. 6, because the virtual hardware elements 65a, 65b, 65c, . . . included in the selection type (select) item information created as the flavour template in advance are displayed as a list in the created catalog item display portion 6l Ab, the user can select any item from the list.

The creation/selection type (create_select) item information has a function of creating a new item or catalog on the spot. It is assumed that, in a state in which the created item or a plurality of items included in the created catalog are displayed as a list in the item pane 61, the user is caused to select any item from the list. It is also assumed that the creation/selection type (create_select) item information is used in a VNF Description (VNFD) of a Network Service Descriptor (NSD) catalog creation screen.

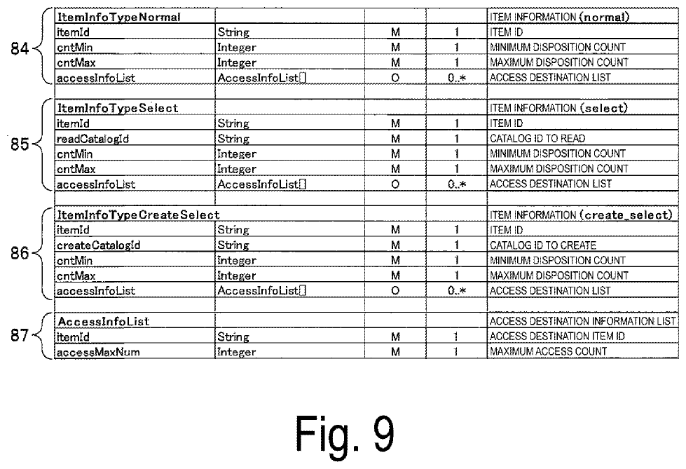

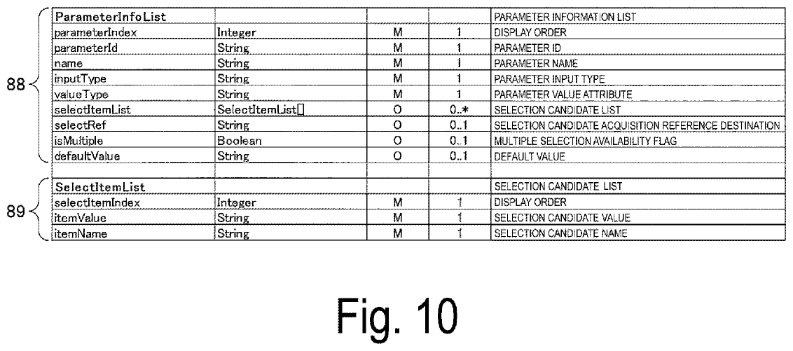

Meanwhile, in FIG. 9, specifications of disposition type item information (ItemInfoTypeNormal) 84, selection type item information (ItemInfoTypeSelect) 85, creation/selection type item information (ItemInfoTypeCreateSelect) 86, and an access destination information list (AccessInfoList) 87 are illustrated. Here, the disposition type item information (ItemInfoTypeNormal) 84, the selection type item information (ItemInfoTypeSelect) 85, and the creation/selection type item information (ItemInfoTypeCreateSelect) 86 represent detailed specifications of three types of item information included in the item information list (ItemInfoList) 83 illustrated in FIG. 8. In FIG. 9, respective categories laterally aligned as in FIG. 8 represent a name of a definition, data type, M/O classification, a data range, and a description of each row in order from the left.

The disposition type item information (ItemInfoTypeNormal) 84 consists of an item ID, a minimum disposition count, a maximum disposition count, and an access destination list, as illustrated in FIG. 9. The access destination list can be omitted. Data types of the item ID, the minimum disposition count, the maximum disposition count, and the access destination list are a character string, an integer, an integer, and an “AccessInfoList” array, respectively. A range of the number of pieces of data in the access destination list ranges from 0 to infinity. When 0 is assigned to any of the minimum disposition count and the maximum disposition count in the disposition type item information (ItemInfoTypeNormal) 84, the disposition count is unlimited.

Further, the selection type item information (ItemInfoTypeSelect) 85 consists of an item ID, a catalog ID to read, a minimum disposition count, a maximum disposition count, and an access destination list. The access destination list can be omitted. Data types of the item ID, the catalog ID to read, the minimum disposition count, the maximum disposition count, and the access destination list are a character string, a character string, an integer, an integer, and an “AccessInfoList” array, respectively. Further, for the selection type item information (ItemInfoTypeSelect) 85, when a catalog is designated, the item ID of the catalog is set as the catalog ID.

A configuration and other specifications of the creation/selection type item information (ItemInfoTypeCreateSelect) 86 are the same as those of the selection type item information (ItemInfoTypeSelect) 85, as illustrated in FIG. 9.

The access destination information list (AccessInfoList) 87 illustrated in Fie. 9 consists of an access destination item ID and a maximum access count. Data types of the access destination item ID and the maximum access count are a character string and an integer, respectively. Further, the maximum access count in the access destination information list (AccessInfoList) 87 represents the maximum access count in which an access source is a base point. For example, when the access source is “1” and the access destination is “2”, “2” is assigned to the maximum access count. Further, when the access source is “1” and the access destination is not limited, “0” is assigned to the maximum access count.

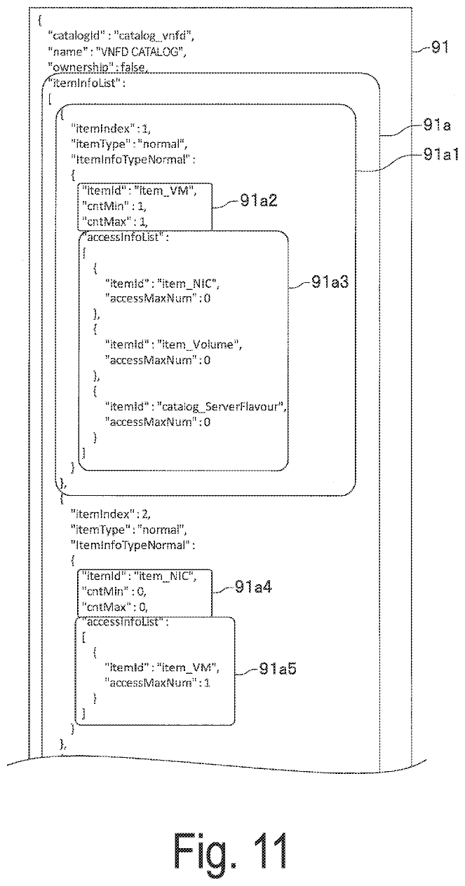

On the other hand, in FIG. 10, specifications of the parameter information list (ParameterInfoList) 88 and the selection candidate list (SelectItemList) 89 are respectively indicated, Here, the parameter information list (ParameterInfoList) 88 is used as a component of the catalog information (CatalogInfo) 81 and the item information (ItemInfo) 82 illustrated in FIG. 8.

A parameter information list (ParameterInfoList) 88 consists of a display order, a parameter ID, a parameter name, a parameter input type, a parameter value attribute, a selection candidate list, a selection candidate acquisition reference destination, a multiple selection availability flag, and a default value, as illustrated in FIG. 10. Among these, the selection candidate list, the selection candidate acquisition reference destination, the multiple selection availability flag, and the default value can be omitted. Further, data types of the display order, the parameter ID, the parameter name, the parameter input type, the parameter value attribute, the selection candidate list, the selection candidate acquisition reference destination, the multiple selection availability flag, and the default value are an integer, a character string, a character string, a character string, a character string, a “SelectItemList” array, a character string, a boolean type, and a character string, respectively.

The parameter name included in the parameter information list (ParameterInfoList) 88 is used as a label for an input category of a screen. Further, the parameter input type is selected from any of “input: input”, “selection: select”, “reference type selection: read_select,” “hidden parameter: hidden,” “hidden parameter indicating reference source ID: read_id,” and “: term.” Further, the parameter value attribute represents an integer or a character string.

The selection candidate list in the parameter information list (ParameterInfoList) 88 is assigned when the parameter input type is “selection: select”. Further, the selection candidate acquisition reference destination is assigned when the parameter input type is “reference type selection: read_select”. Further, the multiple selection availability flag assigns “true”/“false” when the parameter input type is “selection: select” or “reference type selection: read_select”. Further, the default value is “manually input value” when the parameter input type is “input: input”, is an index value of the selection candidate when the parameter input type is “selection: select”, and is a mandatory manually input value when the parameter input type is “hidden parameter: hidden.”

The selection candidate list (SelectItemList) 89 illustrated in FIG. 10 is used as one of components of the parameter information list (ParameterInfoList) 88. This selection candidate list (SelectItemList) 89 includes a display order, a selection candidate value, and a selection candidate name. Data types of the display order, the selection candidate value, and the selection candidate name are an integer, a character string, and a character string, respectively. The selection candidate name of the selection candidate list (SelectItemList) 89 is used for display of the selection candidate.

Specific Example of Definition Content of Catalog Definition File

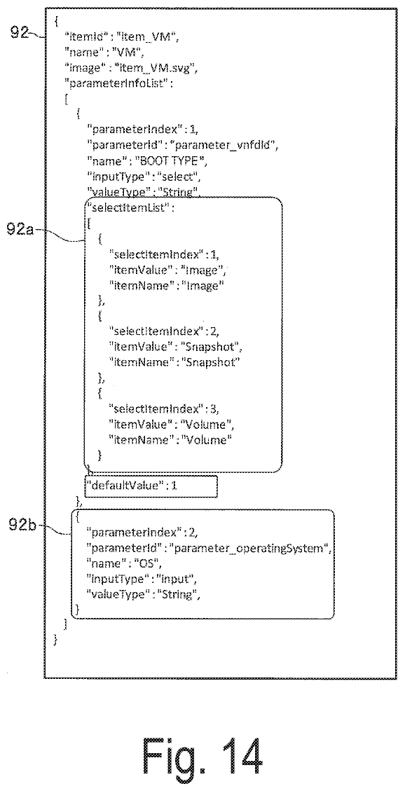

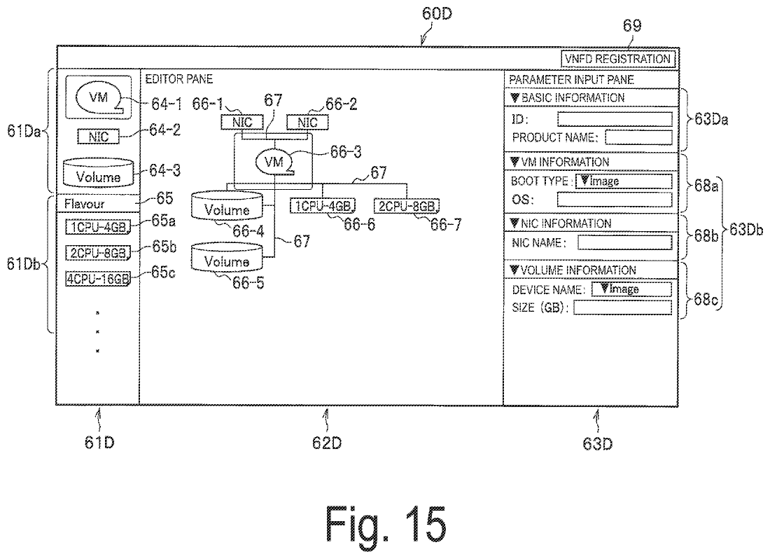

An example of a definition of specific catalog information (CatalogInfo) 81 in the catalog definition file 41 is illustrated in FIGS. 11 to 13. Further, an example of a definition of the specific item information (ItemInfo) 82 in the catalog definition file 41 is illustrated in FIG. 14. Further, a specific example of the catalog creation screen corresponding to the definition content illustrated in FIGS. 11 to 14 is illustrated in FIG. 15. Content illustrated in FIGS. 11 to 15 will be described below.

A catalog definition example 91 illustrated in FIGS. 11 to 13 represents a definition of a “VNFD catalog” as described in the beginning of FIG. 11. Further, description of ““ownership”: false,” on a third line indicates that there is no parent-child relationship between items. Thus, in this case, a catalog component 67 displayed in an editor pane 62D of a catalog creation screen 60D illustrated in FIG. 15, that is, a connection line of a connector connecting between items is displayed as a normal straight line without directionality. That is, the catalog file creation assistance GUI generation unit 44 generates such GUI data. When ““ownership”: true,” is described, GUI data having an arrow indicating the direction of the parent-child relationship in the connection line of the connector is generated by the catalog file creation assistance GUI generation unit 44.

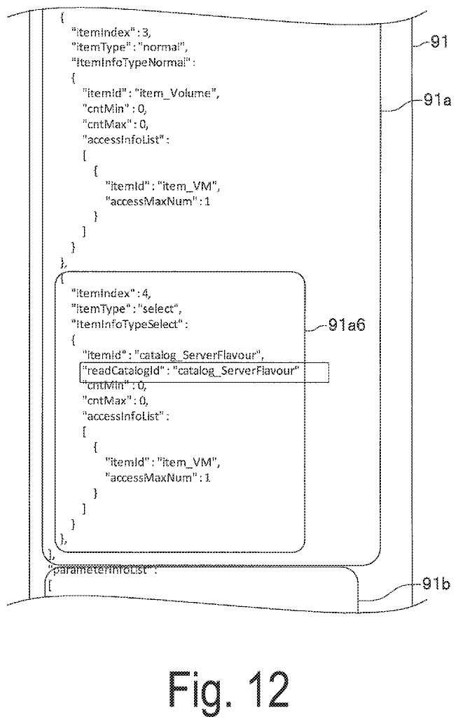

A VNFD catalog definition portion 91a illustrated in FIGS. 11 and 12 represents the item information list (ItemInfoList) 83. Each of items of the content defined here is displayed in item pane 61D illustrated in FIG. 15.

For example, a definition portion 91a1 representing an item having an index of “1” is included in the item information list (ItemInfoList) 83 of the VNFD catalog definition portion 91a, The items defined here are normal items of a disposition type, that is, ““ItemType”: normal.” Further, an ID of the item having the index “1” is “Item VM” indicating the virtual machine as defined by the definition portion 91a2. This item is displayed as the item 64-1 in the item pane 61D illustrated in Fie. 15. Further, this item 64-1 can be dragged and dropped and displayed as the catalog component 66-3 in the editor pane 62D.

A definition portion 91a3 in FIG. 11 defines an access destination list (AccessInfoList) regarding an item having an index of “1”, In an example of the definition portion 91a3, it is illustrated that an item having an index of “1” can be connected to a plurality of items without limitation, with each of NIC, Volume, and Flavour being an access destination. Thus, the catalog component 66-3 and another item can be connected by the connector of each catalog component 67, as in the editor pane 62D in FIG. 15.

A definition portion 91a4 in FIG. 11 defines an item of the NIC as an item having an index of “2”. Further, there is no limitation on the number of NICs. This item (NIC) can be connected to a virtual machine (VM), as defined by an access destination list (AccessInfoList) of a definition portion 91a5, but the maximum number of connectable virtual machines is limited to “1”.

Thus, for example, in the editor pane 62D of FIG. 15, the connector of the catalog component 67 that connects the NICs of the catalog components 66-1 and 66-2 and the VM of the catalog component 66-3 is subject to restrictions of the definition portion 91a5.

Meanwhile, a definition portion 91a6 illustrated in FIG. 12 defines an item having an index of “4”. This is a selection type (select) item, and represents a created catalog of the Flavour. Further, here, “catalog_ServerFlavour” is designated as “catalog ID to read: readCatalogid” of the selection type item information (ItermInfoTypeSelect). That is, data of the template can be read from a file of the designated catalog and used as an item.

With this definition portion 91a6, it is possible to display the flavour display portion 65 on a created catalog item display portion 61Db of the item pane 61D illustrated in FIG. 15, for example, and to display the virtual hardware elements 65a, 65b, 65c, of the template included in the flavour.

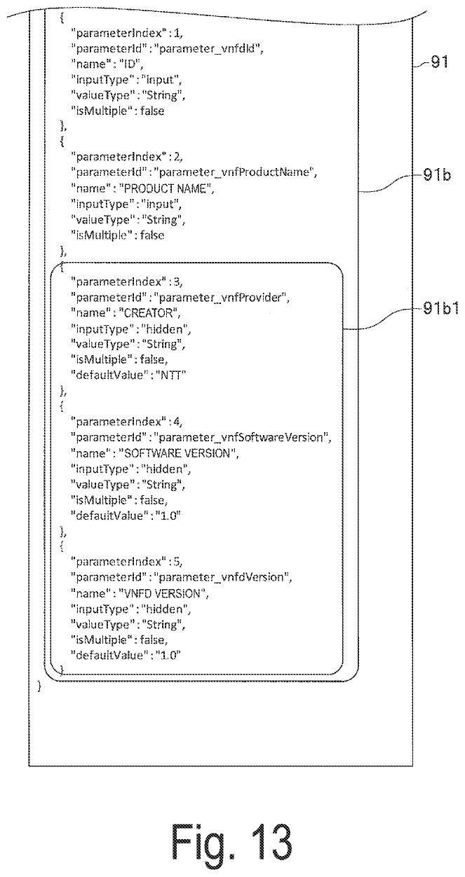

Meanwhile, a parameter information list 91b illustrated in FIGS. 12 and 13 corresponds to the parameter information list (ParameterInfoList) 88 in Fie. 10, and represents a basic information parameter of the VNFD. Thus, for example, content of the parameter information list 91b is displayed in a basic information display portion 63Da of a parameter input pane 63D illustrated in FIG. 15.

However, each of parameters having indexes “3”, “4”, and “5” of Which “InputType”: “hidden” is designated as in a definition portion 91b1 is hidden, and a value designated in “default value: defaultValue” is assigned,

Meanwhile, an item definition example 92 illustrated in FIG. 14 defines a virtual machine VM as an item that can be used in the catalog. In an example of the item definition example 92, because image information “image:item_VM.svg” is designated in a third line, this image information can be used as GUI data representing the virtual machine VM that is an item.

A parameter definition portion 92a in the item definition example 92 corresponds to the selection candidate list (SelectItemList) 89 illustrated in FIGS. 10, and is included in the parameter information list (ParameterInfoList) 88 illustrated in FIG. 10. Content of the item definition example 92 in FIG. 14 is reflected in a VM information display area 68a of an item information display portion 63Db of the parameter input pane 63D illustrated in FIG. 15.

In the example of the parameter definition portion 92a, “image”, “Snapshot”, and “Volume” represented by indexes “1”, “2”, and “3”, respectively, are defined in the selection candidate list (SelectItemList). That is, “image”, “Snapshot”, and “Volume” that are the selection candidates are displayed in the VM information display area 68a, and become selectable by user input. Further, because “1” is assigned to “default value: defaultValue” following the parameter definition portion 92a, “image” corresponding to the index “1” is displayed in the VM information display area 68a in an initial state and selected.

A parameter definition portion 92b defines a “manual input: input” type parameter. This parameter definition portion 92b is a definition for specifying an operating system (OS), and the content is determined by the catalog creator inputting a parameter of a character string to an input field at the bottom of the VM information display area 68a illustrated in FIG. 15 through manual operation input. That is, the catalog file creation assistance GUI generation unit 44 generates data of the GUI necessary for such a parameter input environment based on definition of the parameter definition portion 92b.

Display content of each of the NIC information display area 68b and the volume information display area 68c illustrated in FIG. 15, that is, the GUI is also determined by the same definition as the item definition example 92 illustrated in FIG. 14,

For example, when the catalog creator operates a “VNFD registration” button 69 displayed on the catalog creation screen 60D in FIG. 15, GUI data of the catalog that is being created can be stored as an intermediate file or a completed catalog can be registered. The catalog file generation unit 48 automatically generates the catalog to be created based on the content edited in the editor pane 62D, that is, final GUI data including an editing result composed of a plurality of items and connectors connecting these, the basic information of the parameters, and the parameters input in the parameter input pane 63D.

Advantages of Catalog Creation Assistance Device 40

As described above, in the catalog creation assistance device 40 illustrated in FIG. 4 the catalog file creation assistance GUI generation unit 44 generates the GUI data 55 to be displayed on the creation assistance screen for the creation target catalog in a format that allows the web browser 51 to display, based on the content of the catalog definition file 41. Further, the catalog file creation assistance GUI unit 45 can receive a request from the web browser .51 and reply with an appropriate response in the creation assistance screen. The catalog file creation assistance GUI generation unit 44 can dynamically create GUI data that can be displayed on the creation assistance screen in response to a request from the web browser 51 received by the catalog file creation assistance GUI unit 45.

Thus, when the appropriate catalog definition file 41 is prepared in advance, the GUI data 55 can be automatically generated based on the catalog definition file 41 without individually developing GUI data for each catalog. In particular, for the content of the catalog definition file 41, because it is not necessary to define content of a service specification required by the catalog to be created, versatile use of the same catalog definition file 41 becomes possible when catalogs for various services are created. Further, because it is not necessary to develop the GUI data individually for each catalog, it is possible to create, when the new service is added, a catalog corresponding to a new service in a short time. Further, because the catalog creation assistance device 40 displays an appropriate GUI on the screen when the catalog creator creates a catalog, the catalog creator can intuitively ascertain a situation from the visual information and create the catalog efficiently.

Assistance Screen Display Method

When the catalog creator creates catalogs using the catalog creation assistance device 40 illustrated in FIG. 4, the catalog definition file management unit 43 manages the catalog definition file 41, for example, to generate the catalog creation screen 60A illustrated in FIG. 6. Further, the catalog file creation assistance GUI generation unit 44 and the catalog file creation assistance GUI unit 45 generate appropriate GUI data based on the defined content and an input operation of the user. This GUI data includes, for example, a catalog configuration for specifying a plurality of items, a connection relationship between items, and parameters of each item included in the creation target catalog, like the content of the editor pane 62A and the parameter input pane 63A illustrated in FIG. 6, That is, a layout and a connection relationship between elements in the catalog configuration can be displayed on the creation assistance screen in a graphically visible state. Thus, the catalog creator can intuitively ascertain a creation situation of the catalog through the GUI displayed on the creation assistance screen.

Catalog Creation Assistance Method

The catalog definition file 41 used by the catalog creation assistance device 40 includes the catalog definition 41A and the item definition 41B, for example, as illustrated in FIG. 7. This allows versatile use of the common catalog definition file 41, and when various types of catalogs are created, a GUI suitable for a creation target catalog can be displayed on the creation assistance screen.

Further, for example, in the definition specification illustrated in FIG. 8, three types of items including the disposition type, the selection type, and creation/selection type can be selected when each item of the catalog definition file 41 is defined. That is, a first item definition portion for individually defining a single item, a second item definition portion for defining an item selectable from among a created group consisting of a plurality of items, and a third item definition portion for defining an item selectable from among an uncreated group consisting of the plurality of items can he defined in the catalog definition file 41, With such catalog creation assistance method, it is possible to easily create various types of catalogs,

### REFERENCE SIGNS LIST

10 API cooperation device
11 Catalog interpretation execution unit
12 Service API execution unit
12a, 12b, 12c Individual unit
13 Catalog management unit
14 Company D network
15 Company A cloud
16 Application A
20 Cooperation service catalog
21 Company D catalog
22 Company A catalog
22a, 22b, 22c, 23a, 23b, 23c Component corresponding portion
22d, 23d Action rule
23 Application A catalog
30 API Orchestrator
31 Catalog
32 Adapter
35a, 35b, 35c, 35d, 35e API framework
FB Wholesale service
FB1, FB2, FB3, FB4 First B operator
MB Middle B operator
X1 End user
40 Catalog creation assistance device
41 Catalog definition file
41A Catalog definition (Catalog information definition portion)
41B Item definition (item definition portion)
41a Catalog ID definition portion
41b Catalog name definition portion
41c Basic information definition portion
41d Component item definition portion
41e Item ID definition portion
41f Item name definition portion
41g Item configuration category list
42 Catalog definition file registration unit
43 Catalog definition file management unit (definition file management unit)
44 Catalog file creation assistance GUI generation unit (GUI generation unit)
45 Catalog file creation assistance GUI unit (GUI unit)
46 Catalog creation intermediate file generation unit
47 Catalog file management unit
48 Catalog file generation unit
49 Other-system cooperation unit
51 Web browser
52 User input
53 Display
55 GUI data
55a, 61, 61A, 61B, 61C Item pane (first area)
55b, 62. 62A, 62B, 62C Editor pane (second area)
55c, 63, 63A, 63B, 63C Parameter input pane (third area)
60, 60A, 60B, 60C, 60D Catalog creation screen
61Aa, 61Ba Individual item display portion
61Ab Created catalog item display portion
63Aa Basic information display portion
63Ah, 63Ca Item information display portion
65 Flavour display portion
65a, 65b, 65c Virtual hardware element
66-1, 66-2, 66-3, 66-4, 66-5, 66-6 Catalog component
66-7, 67, 62Ca, 62Ch, 62Cc Catalog component
68a VM information display area
68b NIC information display area
68c Volume information display area
81 Catalog information (CatalogInfo)
82 Item information (ItemInfo)
83 item information list (ItemInfoList)
84 Disposition type item information (ItemInfoTypeNormal: first item definition portion)
85 Selection type item information (ItemInfoTypeSelect: second item definition portion)
86 Creation/selection type item information (ItemInfoTypeCreateSelect: third item definition portion)
87 Access destination information list (AccessInfoList: connection parameter)
88 Parameter information list (ParameterInfoList)
89 Selection candidate list (SelectItemList)
91 Catalog Definition example
91a VNFD Catalog definition portion
91a1, 91a2, 91a3, 91a4, 91a5, 91a6, 91b1 Definition portion
91b Parameter information list
92 Item definition example
92a, 92b Parameter definition portion

1. A catalog creation assistance device that is configured to assist with creation of a catalog handled by an API orchestrator configured to control cooperation between a first operator and a middle operator, the catalog creation assistance device comprising:
a definition file management unit configured to manage a catalog definition file including versatile definition data required to define components, a service specification, and an action rule in a creation target catalog;
a GUI generation unit configured to generate GUI data to be displayed on a creation assistance screen for the creation target catalog in a format that at least a web browser is able to display based on content of the catalog definition file; and
a GUI unit configured to receive a request from the web browser and reply with a response in the creation assistance screen,
wherein the GUI generation unit is configured to create the GUI data displayable on the creation assistance screen in response to a request from the web browser received by the GUI unit.

2. The catalog creation assistance device according to claim 1, wherein the creation assistance screen for the creation target catalog includes:
a first area for displaying a list of assignable items;
a second area having a function of editing a configuration of a catalog to be created; and
a third area enabling parameters regarding at least a selected item from assignable items to be displayed and updated.

3. The catalog creation assistance device according to claim 2, wherein the GUI generation unit is configured to (i) dispose, in the second area, an item selected from a list of assignable items displayed in the first area in response to a drag-and-drop request from the web browser displaying the creation assistance screen for the creation target catalog and (ii) create the GUI data according to a configuration in the second area.

4. The catalog creation assistance device according to claim 2,
wherein each of items of assignable items that are able to be disposed in the first area and the second area includes a connection parameter indicating a list of information for specifying an access destination and a maximum access count, and
wherein the GUI generation unit is configured to connect a plurality of items of assignable items disposed in the second area according to the connection parameter in response to a request from the web browser.

5. The catalog creation assistance device according to claim 4, wherein the GUI generation unit is configured to (i) recognize, when connecting a plurality of items of assignable items disposed in the second area according to the connection parameter in response to a request from the web browser, whether there is a parent-child relationship between a plurality of connected items of assignable items and (ii) represent, based on there being the parent-child relationship, a parent-child relationship using a visually distinguishable connection line having directionality.

6. An assistance screen display method for displaying a creation assistance screen for assisting with creation of a catalog handled by an API orchestrator configured to control controlling cooperation between a first operator and a middle operator, the assistance screen display method comprising:
managing a catalog definition file including versatile definition data required to define components, a service specification, and an action rule in a creation target catalog;
generating a catalog configuration for specifying a plurality of items, connection relationships between the plurality of items, and parameters of each item of the plurality of items included in the creation target catalog based on content defined by the catalog definition file and an input operation of a user; and
displaying, on the creation assistance screen, a layout and a connection relationship between elements in the catalog configuration in a visible state.

7. A catalog creation assistance method for assisting with creation of a catalog handled by an API orchestrator configured to control cooperation between a first operator and a middle operator, the catalog creation assistance method comprising:
using a versatile catalog definition file serving as a basis for a creation target catalog; and
disposing, in the catalog definition file, a catalog information definition portion for specifying basic information of the catalog and an item definition portion for specifying a plurality of items includable in the catalog.

8. The catalog creation assistance method according to claim 7, wherein the item definition portion includes a first item definition portion for individually defining a single item of the plurality of items, a second item definition portion for defining an item of the plurality of items selectable from among a created group consisting of the plurality of items, and a third item definition portion for defining an item of the plurality of items selectable from among an uncreated group including the plurality of items.
